(19) United States
(12) Patent Application Publication
(10) Pub. No.: US 2022/0360755 A1
(43) Pub. Date: Nov. 10, 2022

(54) INTERACTIVE DISPLAY WITH INTEGRATED CAMERA FOR CAPTURING AUDIO AND VISUAL INFORMATION

(71) Applicant: Ji SHEN, Las Vegas, NV (US)

(72) Inventor: Ji SHEN, Las Vegas, NV (US)

(21) Appl. No.: 17/865,383

(22) Filed: Jul. 14, 2022

Related U.S. Application Data
(63) Continuation-in-part of application No. 17/079,345, filed on Oct. 23, 2020.
(60) Provisional application No. 63/221,888, filed on Jul. 14, 2021.

(51) Int. Cl. H04N 9/31; G06F 3/0488

(52) U.S. Cl. CPC H04N 9/3194; H04N 9/3182; H04N 9/3185; G06F 3/0488

(57) ABSTRACT

The present invention provides an interactive display screen integrated with a video camera optimized to capture the user, the user's correct gaze, and information inputted on or through the interactive display screen. A presenter writes or draws information on the display screen while facing an audience. The display screen displays digital photos or other multimedia objects that a user can annotate or otherwise manipulate. Meanwhile, the device captures the displayed multimedia information and combines it with a video stream captured from the video camera. No extraneous video production equipment or technical expertise is required to operate while providing a compact and easily transportable system.

### CROSS-REFERENCE TO RELATED APPLICATIONS

This application is a continuation-in-part of and claims priority to U.S. patent application Ser. No. 17/079,345 filed on Oct. 23, 2020, entitled, “Capturing Audio and Visual Information On Transparent Display Screens;” and claims priority to U.S. Provisional Patent Application No. 63/221,888 filed on Jul. 14, 2021, entitled, “Interactive Display with Integrated Camera.” This application is related to United States Design Patent Application No. 29/756,006 filed on Oct. 23, 2020, entitled, “Camera For Capturing Information on a Transparent Medium;” and United States Design Patent Application No. 29/768,320 filed on Jan. 28, 2021, entitled, “Hood For Writing Glass;” the entire disclosures of all of which are incorporated by reference herein.

### BACKGROUND OF THE INVENTION

### 1. Field of Invention

The invention relates to capturing information on display screens.

### 2. Description of Related Art

Handwriting remains an indispensable tool for teaching and instruction, for example, for students in a classroom, professionals in a business meeting, scholars at a conference, or anyone who wants to convey information to an audience. Traditionally, when an instructor, teacher, or presenter writes on a surface, it is often a whiteboard with a dry-erase marker, a blackboard with chalk, an interactive digital panel display with a stylus or hand/finger gestures. The whiteboard, blackboard, or other surface is typically mounted or stationed along a room wall. For example, teachers will often lecture at the head of a room with a whiteboard mounted behind them. A significant drawback to this orientation is that it requires the teacher or presenter to turn their back to the audience to write on the display screen.

While Lightboards, for example, present visual information on a transparent screens and flip an image about to be displayed to an audience correctly, there exist many disadvantages. A significant drawback of the systems is a need for a standalone video capturing system. The Lightboard must include separate components, including a camera, lighting, mirrors, blue light, and specific filters. Not only is the extraneous equipment expensive, but it is bulky, fragile, and difficult to transport, as well as requiring technical expertise to set up and operate.

Further, other examples include devices with electronic motion image cameras for capturing the image of a subject located in front of an image display device and a digital projector for projecting the captured image. However, these systems do not have a built-in image capture device and require expensive, bulky equipment to operate.

Existing methods and tools for collaborating in video conferences use non-electronically enhanced whiteboards and without using electronically enhanced writing and pointing tools. The various video streams are combined in post-processing to provide a single video stream. However, these methods require large, bulky equipment to run with multiple cameras e.g., studio lighting, to create a visually appealing video stream. Each camera must also provide different focal lengths focused on various aspects of a presenter and a whiteboard.

Select interactive displays include user-facing cameras. For example, laptop computers have a camera oriented toward the user. Typically, these cameras are located at the center of the bezel above the screen. This configuration allows individuals to conduct a videoconference where each participant's device captures a video sent to the other participants. The participants view each other while conversing remotely. A common problem is that the videos produced from such devices give the impression that each participant is looking below the camera because they are typically looking at the device's screen and not the camera. This detracts from the personal experience because the “eye-to-eye” contact is not maintained.

While video conferencing systems can assist a user in enabling a gaze-accurate video conference and screens that alternate between a substantially transparent state and a light scattering state, there exist numerous disadvantages. Current systems require a screen, a camera, a projector, a face detection system, and a synchronization system. To implement this screen, a synchronization system must also interact with the projector and a video camera. As such, bulky equipment to implement the systems is required.

In light of these challenges in the field, there is a need for a display screen on which a user can present information with an integrated camera and allows the presenter to face the audience while writing on the display screen. Also needed is a compact, easy to transport, and easy to use device with an integrated camera oriented and located such that the presenter's gaze is directed to the camera while viewing the display screen. This need has heretofore remained unsatisfied.

### SUMMARY OF THE INVENTION

The present invention overcomes these and other deficiencies of the prior art by providing a display screen integrated with a video camera optimized to capture information on the display screen and to correct a user's gaze. A presenter writes or draws information on the display screen while facing an audience. The present invention does not require extraneous video production equipment or technical expertise to operate while providing a compact and easily transportable system.

In an embodiment of the invention, a device comprises: a display screen; a frame traversing at least a portion of a perimeter of the display screen; an extension comprising a distal end and a proximal end, wherein the proximal end of the extension is connected to the frame; and a video camera coupled to the extension. The frame comprises a light source injecting light into an edge of the display screen. The device may further comprise a stand coupled to the frame. The display screen comprises a first surface and a second surface opposite the first surface, and wherein the extension extends from the second surface. The video camera is coupled to the extension at the distal end and oriented in a direction toward the second surface. The display screen is transparent and comprises a material selected from the group consisting of: glass, acrylic, plexiglass, polycarbonate, cellophane, latex, polyurethane, melamine, vinyl, polyester, and any combination thereof. The video camera comprises a filter having a frequency band, including the frequency of the injected light.

In another embodiment of the invention, a method for capturing visual information comprises the steps of: capturing, with a video camera coupled to an extension coupled to a display screen, information presented on the display screen; processing the captured information into processed information; and transmitting the processed information to a display. Processing the captured information comprises reorienting captured multimedia information about a vertical axis or superimposing a predetermined image or video. The method may further comprise injecting, from a light source connected to the frame, light into an edge of the display screen. The display screen is transparent and comprises a material selected from the group consisting of: glass, acrylic, plexiglass, polycarbonate, cellophane, latex, polyurethane, melamine, vinyl, polyester, and any combination thereof.

In yet another embodiment of the invention, an apparatus comprises: a display screen; a frame traversing at least a portion of a perimeter of the display screen; an extension connected to the frame; a video camera coupled to the extension; at least one processor; and at least one memory including computer program code for one or more programs, the at least one memory and the computer program code configured to, with the at least one processor, cause the apparatus to perform at least the following, capturing, with the video camera, information presented on the display screen; processing the captured information; and transmitting the processed information to a display. The apparatus may further comprise a light source injecting light into an edge of the display screen. The extension is connected to the frame at a proximal end of the extension, and wherein the video camera is coupled to a distal end of the extension, the distal end is located opposite the proximal end. The display screen comprises a first surface and a second surface opposite the first surface, the extension extends from the second surface, and the video camera is oriented in a direction toward the second surface. The display screen is transparent and comprises a material selected from the group consisting of: glass, acrylic, plexiglass, polycarbonate, cellophane, latex, polyurethane, melamine, vinyl, polyester, and any combination thereof.

Advantageously, the present invention provides an interactive display screen that is transparent, such as a transparent liquid crystal display (“LCD”) or organic light emitting diode (“OLED”) display, with an optional touchscreen. The interactive display screen may display digital photos or other multimedia objects that a user can annotate or otherwise manipulate. The device captures the displayed multimedia information and combines it with a video stream captured from a video camera.

In an exemplary embodiment of the present invention, the device comprises a hood. The hood has a left panel extending from the device in a direction toward the image capture device, a right panel extending from the device in a direction toward the image capture device, a top panel extending from the device in a direction toward the image capture device, and an apron extending from the top panel, wherein the apron is convertible from a first position to a second position. In some embodiments, the hood is rigid and removably attached to the frame. In other embodiments, the hood is flexible and removably attached to the frame. In another embodiment, the presentation device comprises a hood support extending from the frame in a direction toward the image capture device, wherein the hood is supported by the hood support. In some embodiments, the hood support comprises a plurality of rods. In some embodiments, the hood further comprises a second light source that provides backlighting for the transparent display screen. In another embodiment, the present invention comprises a touch-sensitive panel.

In another exemplary embodiment, the present invention enables a method of presenting and capturing visual information, comprising the steps of injecting, from a light source integrated into a frame, light into a transparent display screen, wherein the frame traverses at least a portion of the display screen; capturing, with an image capture device, a first video stream, wherein the image capture device is integrated into to the display screen; generating an output video stream; and outputting the output video stream over a network. In another embodiment, the step of generating an output video stream comprises the steps of receiving the first video stream from the image capture device; reorienting the first video stream about a vertical axis; receiving a second video stream, the second video stream comprising multimedia information displayed on a display screen; and merging the first video stream and the second video stream into the output video stream. In another embodiment, the step of merging the first video stream and the second video stream comprises the steps of detecting a set of visual objects in the second video stream; adjusting visual characteristics of the set of visual objects, the visual characteristics relating to opacity, tint, hue, brightness, color intensity, or size of the set of visual objects; and superimposing the adjusted set of visual objects onto the first video stream. In another embodiment, the present invention further comprises the step of displaying a graphical user interface on the display screen, wherein the graphical user interface is configured to adjust visual characteristics. In another embodiment, the present invention comprises the step of adjusting the amount of ambient light interacting with the writing surface by adjusting an apron of a hood, the apron adjustable between a first position and a second position, wherein the hood further comprises a left panel extending from the device in a direction toward the image capture device, a right panel extending from the device in a direction toward the image capture device, and a top panel extending from the device in a direction toward the image capture device, wherein the apron extends from the top panel of the hood. In another embodiment, the transparent writing surface comprises a touch-sensitive panel.

In another exemplary embodiment of the present invention, a device comprises a transparent display screen comprising a display cycle characterized by oscillating periods of displaying visual information and not displaying visual information at a predetermined display frequency, an image capture device oriented in a direction toward to the transparent display screen and comprising an image capture cycle characterized by oscillating periods of capturing visual information and not capturing visual information at a predetermined capture frequency, wherein the display cycle of the transparent display screen is offset by 180 degrees from the image capture cycle of the image capture device. In another embodiment, the image capture device is movable about a vertical axis and a horizontal axis, and is pivotable about the vertical axis and the horizontal axis. In another embodiment, the image capture device's orientation or position is periodically adjusted to optimize its perspective relative to a user's gaze. In another embodiment, the invention further comprises a photoelectric sensor configured to detect the display cycle or the display frequency of the transparent display screen. In an embodiment, the image capture frequency or the image capture cycle is periodically adjusted based on an output of the photoelectric sensor. In another embodiment, the transparent display screen further comprises a touch-sensitive panel.

The present invention has many advantages over the prior art. For example, the present invention provides a “turn-key” solution to many problems experienced in the relevant art, i.e., easily implemented and requires little to no setup and adjustment before use. Various components of the present invention are pre-optimized to work together. The video camera is pre-configured to work seamlessly with the display screen by, for example, having an optimal focal length for use with the display screen, having filters pre-loaded or pre-installed, and by providing a fixed distance and angle from the display screen. Additionally, the display screen includes built-in lights that project a specific spectrum of light for the display screen's optimal illumination. These lights are also easily controlled by a built-in control panel while being pre-optimized to maximize visibility and legibility to a viewer. Such features remove all of the guesswork in setting up and provide a compact, lightweight, and easy transport package.

The foregoing and other features and advantages of the invention will be apparent from the following, a more detailed description of the invention's preferred embodiments and the accompanying drawings.

### BRIEF DESCRIPTION OF THE DRAWINGS

For a complete understanding of the present invention and advantages thereof, reference is now made to the ensuing descriptions taken in connection with the accompanying drawings briefly described as follows:

FIGS. 1A and 1B illustrate an exemplary device for capturing writing according to an embodiment of the invention;

FIG. 2 illustrates an exemplary device for capturing board writing with markings shown;

FIGS. 3A, 3B, and 3C illustrate an exemplary device for capturing board writing with displays and displaying multimedia information, according to an embodiment of the invention;

FIG. 4 illustrates an exemplary system for capturing board writing, according to an embodiment of the invention;

FIG. 5 illustrates an exemplary flowchart for annotating, managing, and manipulating rich media digital content on a display, according to an embodiment of the invention;

FIG. 6 illustrates exemplary perspective views of a device for capturing board writing with the video camera in an upright orientation, according to an embodiment of the invention;

FIGS. 7A, 7B, and 7C illustrate an exemplary device for capturing board writing with a hood in a closed position, according to an embodiment of the invention;

FIGS. 8A, 8B, and 8C illustrate an exemplary device for capturing board writing with a hood in an open position, according to an embodiment of the invention;

FIG. 9 illustrates exemplary perspective views of a device with an integrated image capture device, according to an embodiment of the invention; and

FIGS. 10A and 10B illustrate exemplary display cycles and capture cycles, according to an embodiment of the invention.

Throughout the drawings, identical reference characters and descriptions indicate similar, but not necessarily identical, elements.

### DETAILED DESCRIPTION OF PREFERRED EMBODIMENTS

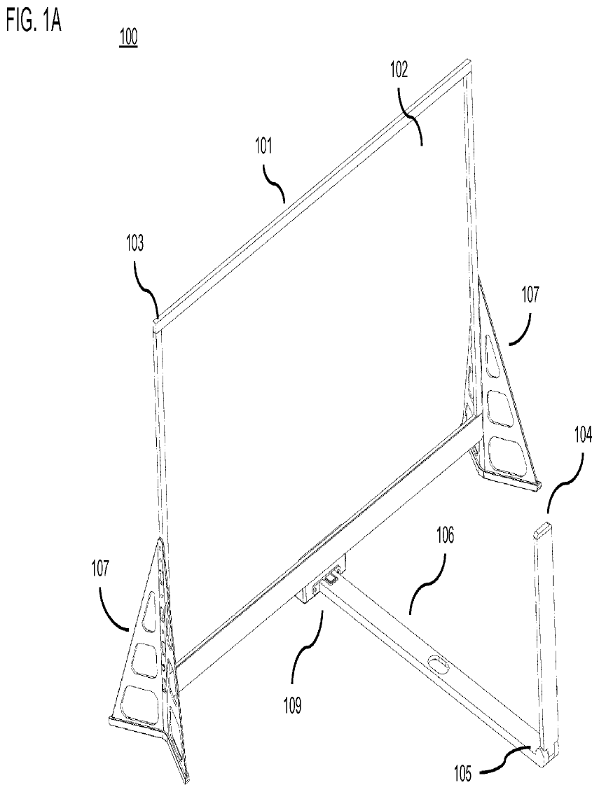

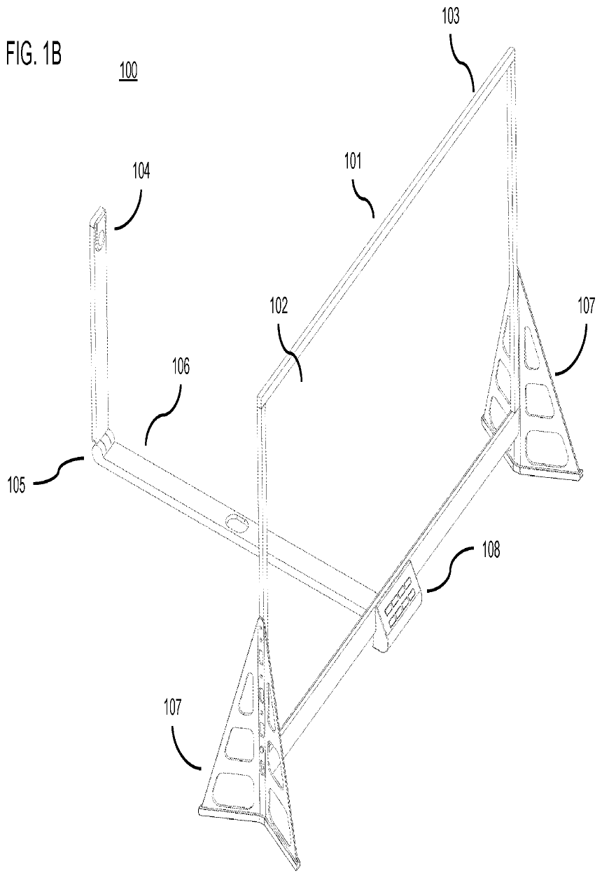

Preferred embodiments of the present invention and their advantages may be understood by referring to FIGS. 1-10. The described features, structures, or characteristics of the invention may be combined in any suitable manner in one or more embodiments. It will be apparent to those skilled in the art that modifications and variations can be made to the present invention without departing from the invention's spirit and scope. Thus, it is intended that the current invention cover all modifications and variations consistent with the scope of the appended claims and their equivalents.

The present invention provides a solution for capturing audio and visual information presented on a transparent display screen while permitting a user (writing on the screen) to face an audience and an image capture device. For simplicity, a display screen or writing surface with transparent, semi-transparent, or translucent properties may be referred to herein as a display screen, a transparent display screen, a transparent writing surface, or an interactive display screen. The integrated image capture device is configured and oriented to produce a video stream of a user where the user appears to look into the image capture device with the correct gaze, preserving eye-to-eye contact. The display screen also includes digital displays such as liquid crystal displays (“LCD”), transparent liquid crystal displays (“TLCD”), transparent organic light-emitting diode (“OLED”) displays, referred to as organic electroluminescent diode displays. An advantage of using a digital display integrated with a transparent writing surface is that multimedia information is displayed while a user simultaneously writes or draws on the display. For example, the user may annotate rich media, including pictures, videos, or other information. Such digital displays may require backlighting, which may be synchronized with the digital display. The display screen may be integrated with a video camera to capture the user's annotation and the rich media.

FIGS. 1A and 1B illustrate opposite views of a presentation device 100 according to an embodiment of the invention. Presentation device 100 comprises a transparent display screen 101 with a writing surface 102 and frame 103 surrounding some or all of writing surface 102. Display screen 101 is any rigid, semi-rigid, or flexible material that is substantially, if not completely, transparent. Substantially transparent refers to a degree of transparency sufficient to convey information presented (and optionally the user) on one side of writing surface 102 to the opposite side of writing surface 102. As noted above, the term transparent as used herein includes semi-transparent and translucent properties for ease of reference and includes interactive digital displays. Presentation device 100 further comprises image capture device 104 coupled to frame 103 via hinge 105 and extension 106. Hinge 105 permits image capture device 104 to fold toward display screen 101 for efficient transport. Some embodiments may optionally include another hinging mechanism attaching extension 106 to frame 103 at connector 109.

For example, display screen 101 is embodied by a sheet of glass. Preferably, the glass is tempered to provide strength and add safety if the glass display screen 101 breaks or shatters. However, display screen 101 can be a sheet of acrylic, plexiglass, polycarbonate, cellophane, latex, polyurethane, melamine, vinyl, polyester, or any combination thereof. In some embodiments, display screen 101 and writing surface 102 are a single layer of homogenous material, or in other embodiments, display screen 101 and writing surface 102 are multi-layered with two or more sheets of material, which may be different or the same. Again, whether a single layer or multi-layered, a layer may comprise an interactive digital display. In such multi-layered embodiments, one or more of the outer layers may be a protective layer that is easily interchangeable/replaceable to guard against scratching or damaging any of the layers. In such an embodiment, the protective layer is thin and inexpensive so that when damaged, it is easily changed.

In another embodiment of the invention, display screen 101 or writing surface 102 may comprise a touch-sensitive interface or touchscreen, the identification and implementation of which are apparent to one of ordinary skill in the art. A user may use a stylus, digital pen, or various hand and finger gestures to interact with a graphical user interface facilitated by the touchscreen to draw, annotate, or otherwise control media displayed on display screen 101.

Although display screen 101 is shown as rectangular and flat, any shape or orientation may be implemented. For example, display screen 101 may be circular or ovular in shape. Also, display screen 101 can be curved to focus light directly on the audience or image capture device 104. In a curved embodiment, the curvature may be optimized for the field of view of image capture device 104, for example, to capture the entire display screen 101 or to preserve the aspect ratio of objects or information displayed on display screen 101 when displayed on a separate display (not pictured).

Frame 103 comprises any suitable material, for example, any rigid or semi-rigid material including, but not limited to, wood, plastic, metal, or any combination thereof. Presentation device 100 utilizes specific types and delivery systems for light to enhance the viewer's or user's experience. In an embodiment of the invention, frame 103 comprises an embedded light source such as one or more light-emitting diodes (“LEDs”) to inject light into display screen 101 and to highlight dry-erase ink, preferably neon dry erase ink, deposited on writing surface 103. The injected light may be in the visible spectrum or outside the visible spectrum, such as ultraviolet, i.e., blacklight, or infrared. Where display 101 comprises an interactive digital display, light from the interactive digital display may provide some illumination for the dry-erase ink deposited on writing surface 102.

Additionally, a built-in light source has the advantage of having its incidence angle, i.e., the angle at which the light interacts with the display screen, predetermined to maximize visibility to a viewer while minimizing its intrusion or glare to the user. In such embodiments where particularized wavelengths of light are injected, image capture device 104 or accompanying software or firmware may comprise filters to remove unwanted colors/effects from the captured multimedia information. In an embodiment of the invention, the one or more filters correspond to the frequency of injected light. The light source also may be controlled by software to change the color of the injected light. Also, image capture device 104 may implement polarization filters. For example, if a confidence monitor is implemented to assist the presenter, a polarization filter eliminates reflections on writing surface 102 from the confidence monitor.

In some embodiments, the injected light may be used to illuminate a display embedded within display screen 101. For example, certain digital displays, e.g., liquid crystal displays (“LCDs”), require backlighting to ensure images displayed thereon are visible. The backlighting may be provided by light sources integrated into presentation device 100. In some embodiments, the injected light, for example, can operate as the backlight for a digital display embedded within display screen 101. To achieve this, the embedded light sources can emit different types of light. For example, the embedded light sources can emit colored light to enhance the visibility of ink drawn on writing surface 102 while others can provide white light (or other wavelengths) to serve as the backlighting for an embedded digital display. In other embodiment, a hood (described herein) may also have one or more embedded light sources that provide backlighting and/or injected light.

Image capture device 104 is any type of video capture device, video camera, motion capture device, or any other similar device to capture and record media. For example, image capture device 104 may comprise a document camera, a single-lens reflex (“SLR”) camera, a digital SLR (“DSLR”) camera, a mirrorless camera, a digital camcorder, or a sports or action camera. The integrated image capture device 104 may be detachably coupled as a modular camera to hinge 105 or extension 106. Image capture device 104 may further be configured such that its orientation can be adjusted. In such an embodiment, image capture device 104 may pivot or move about one or more axes. For example, image capture device's 104 orientation may be adjusted up-and-down and left-to-right. Presentation device 100 or an external computer attached thereto may cause image capture device 104 to be adjusted periodically. In such an embodiment, image capture device 104 may be configured to follow or track the presenter's eyes, face, or gaze. In this way, the present invention ensures image capture device 104 is always pointed at the user.

Providing an integrated image capture device 104 has several advantages over the prior art. Notably, the field of view (“FOV”), i.e., the amount of visible area, is tailored to specific applications. For example, the FOV includes writing surface 102 but does not include frame 103 or other extraneous objects. Tailoring the FOV can be accomplished in image capture device's 104 hardware by, for example, having an optical sensor with a predetermined size to match that of writing surface 102 or optimizing the length of extension 106, or in post-production, by digitally cropping the captured video to excise unwanted portions. Another optimized parameter is the exposure, i.e., the amount of light per unit area reaching the surface of an image sensor, which is adjusted by shutter speed, lens aperture, sensor sensitivity, or scene luminance. Another parameter that can be optimized is the depth of field, i.e., the distance between the closest and farthest objects in a photo or video stream that appears acceptably sharp. This parameter is important because if image capture device's 104 depth of field is too shallow, writing surface 102 or the user, but not both, will be in focus, detracting from the acceptability of the visual experience provided by the present invention.

In an exemplary embodiment of the invention, image capture device 104 is detachably coupled to the distal end of extension 106. Extension 106 may be detachably coupled to frame 103 at connector 109. Additionally, extension 106 is coupled to image capture device 104 via hinge 105 that allows image capture device 104 to be folded to facilitate easy storage or transportation. For example, hinge 105 may be embodied by a ball-and-socket joint that provides three degrees of freedom. Hinge 105 may also be substituted with any mechanism that permits up to six degrees of freedom to orient image capture device 104. Hinge 105 may also comprise a prismatic joint that allows image capture device's 104 distance from display 101 to be adjusted.

Additionally, the distance between image capture device 104 and hinge 106 can be adjusted by a linear slider or another mechanism. Adjusting hinge 105 correctly positions and orients image capture device 104 relative to display screen 101. In this way, image capture device 104 captures the information on writing surface 102 via video. Because the information on writing surface 102 is marked on the side opposite image capture device 104, the writing is reversed when viewed from the audience's and image capture device's 104 perspectives. Accordingly, the video captured by image capture device 104 is processed to reverse (or “flip”) the image/multimedia information about a vertical axis, thereby reorientating the image/video in a manner that appears visually “correct.” One or more separate displays (not shown) may be employed for displaying the video captured by image capture device 104 to a live audience. The displays may implement touch-sensitive screens permitting users to interact with video from image capture device 104.

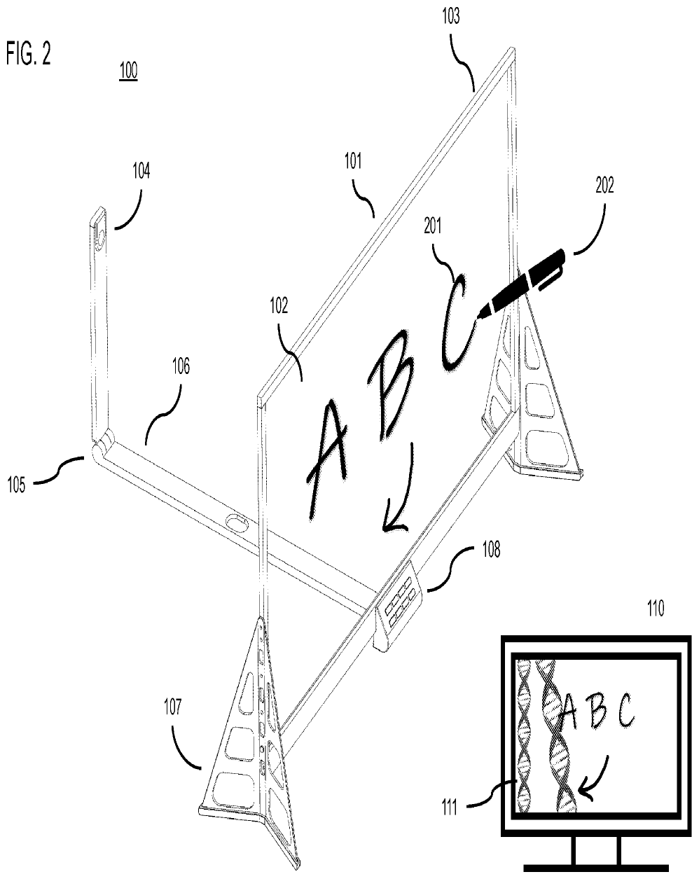

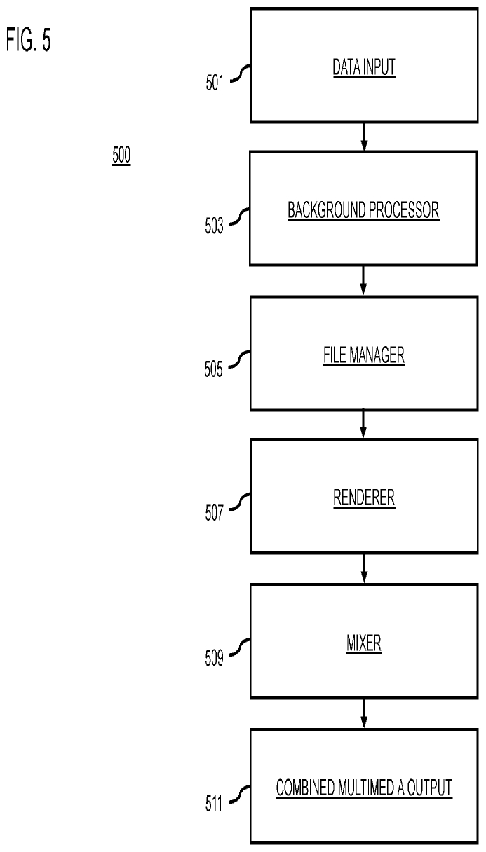

Presentation device 100 facilitates built-in video conferencing in an embodiment of the invention. For example, one or more of the processes discussed with respect to FIG. 5 enables the user to engage in bi-directional video presentations. In such an embodiment, a user initiates a video teleconference wherein image capture device 104 captures video to be shared with other video teleconference members. Video streams containing audience members or other users, i.e., other members of a videoconference, can be displayed on display 101 or confidence monitor 110 (as discussed with respect to FIG. 2).

Presentation device 100 is preferably configured to be free-standing, e.g., set on a table or other horizontal surface. In such an embodiment, presentation device 100 comprises stands 107 that allow display screen 101 to sit in an upright orientation. Stands 107 may include mounts that attach stands 107 to frame 103, and that may also be adjustable to raise or lower display screen 101 and image capture device 104 relative to the horizontal surface on which the presentation device 100 stands.

Presentation device 100 further comprises a control panel 108 used to control presentation device 100. For example, control panel 108 may be configured to control image capture device 104 (or various attributes thereof, e.g., power, exposure, contrast, saturation, DOF, and FOV). Control panel 108 may also control light sources integrated into various parts of presentation device 100, e.g., frame 103. In some embodiments, control panel 108 is embodied by a separate tablet, cellphone, or another smart device. In such an embodiment, control panel 108 may further comprise an interactive display on the display screen 101, configured to view or control the multimedia information captured by image capture device 104, participate in video conferencing, and the like. In other embodiments, control panel 108 comprises an integrated display that may also serve as confidence monitor 110. In some embodiments, the controls discussed with respect to control panel 108 may be implemented by displaying a graphical user interface (GUI) on display screen 101. In such an embodiment, the user can manipulate the controls via the GUI for the added benefit of minimizing the need for extraneous equipment and moving components. Additionally, the GUI may be customized based on the intended use of presentation device 100.

With reference to FIG. 2, a user utilizes a writing instrument 202 to mark a writing 201 on display screen 101. For example, the user (not shown) draws “A B C” 201 on display screen 101 using writing instrument 202. Image capture device 104 captures video that includes writing 201 as it is drawn on writing surface 102. If the display screen 101 is an OLED or LCD display as discussed above, the user may use writing instrument 202 to annotate, manipulate, or otherwise interact with electronic information (e.g., writing 201) displayed on display screen 101. For example, a user displays a picture (e.g., 111) on display screen 101 and uses writing instrument 202 to annotate and/or manipulate it. Presentation device 100 can display physical ink marked on writing surface 102 by a user while capturing those markings digitally via image capture device 104. Writing instrument 202 may be configured to control one or more aspects of presentation device 100. For example, writing instrument 202 may have buttons that a user can use to select between various modes, e.g., a writing mode and an erase mode. In another example, writing instrument 202 may be configured such that the controls are actuated by gestures, e.g., tap, double-tap, triple-tap, shake, which allow the user to control one or more aspects of the presentation device 100.

The present invention also facilitates image insertion. In an embodiment of the invention, image capture device 104 or a computer coupled thereto superimposes a computerized image or video onto the captured video. For example, a computerized image comprises a double-stranded DNA molecule 111. The user can view the double-stranded DNA molecule 111 on a separate confidence monitor 110. In such an embodiment, the molecule 111 may or may not be displayed on writing surface 102. With confidence monitor's 110 aid, the user can write or draw information on writing surface 102 as if the double-stranded DNA molecule 111 was present, thereby creating a captured video having both the information and the double-stranded DNA molecule 111. As depicted in FIG. 2, a user may use writing instrument 202 to draw an arrow on the writing surface 102 to annotate or point to a particular portion of the double-stranded DNA molecule 111. In this way, presentation device 100 creates a single video stream in which the user appears to annotate a digital object (i.e., the double-stranded DNA molecule 111) displayed on the display screen 101 even though the user can only view the object on, for example, confidence monitor 110.

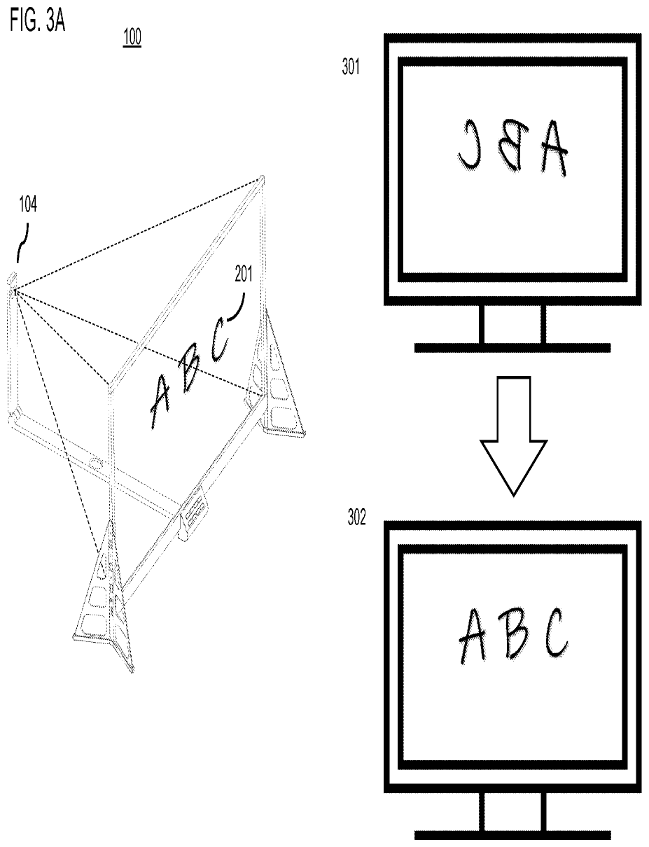

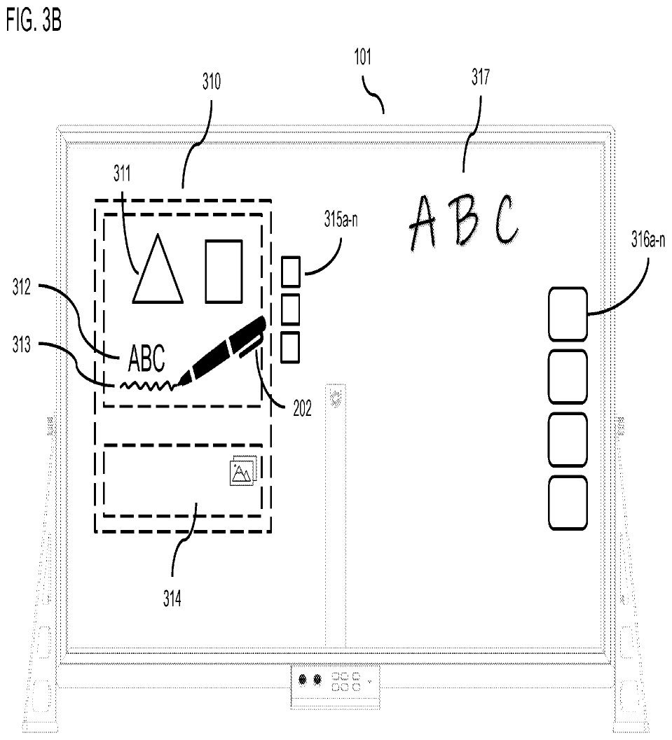

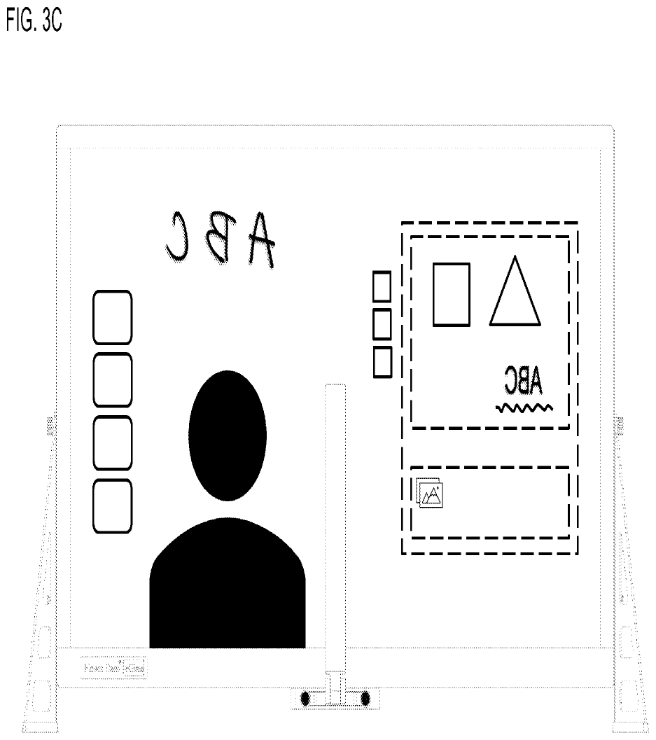

With reference to FIG. 3A, image capture device 104 captures writing 201 from a perspective opposite to that of the user (not shown). If the video captured by image capture device 104 were viewed without processing, the images would be improperly presented to an audience. For example, if displayed without reorientation, writing 201 would appear as shown on display 301, i.e., “A B C” appears reversed. However, presentation device 100 (or a separate computer and/or database or display coupled to it) processes the multimedia information captured by image capture device 104 to reorientate, i.e., flip, it about a vertical axis. Once processed, writing 201 is correctly orientated as viewed by the user, as shown on display 302. In this way, presentation device 100 produces the video rearranged in the correct orientation in real-time or near-real-time, i.e., with an imperceptible delay to an ordinary human observer. In addition to reorientating the video, device 100 can also process the video to effectuate other desired outcomes, such as adjusting the exposure, brightness, focus, saturation, sounds, DOF, FOV, or other audio-visual effects. Other processing techniques may be applied, the identification and implementation of which would be readily understood by one of ordinary skill in the art. Presentation device 100 can also compress the video or sound stream to decrease latency, decrease the storage space required, or facilitate transmissibility, the implementation of which is readily apparent to one of ordinary skill in the art. Although audio and sound are discussed herein as pertaining to multimedia information, any type of multimedia information may be used without departing from the contemplated embodiments.

As shown in FIG. 3B, presentation device 100 may also display multimedia or other information on display screen 101 by incorporating, for example, a digital display, e.g., an LCD or OLED display. Some embodiments further include a touch-sensitive display that may be optionally integrated into display screen 101. In such an embodiment, the user may display a multimedia window 310 on display screen 101, including multimedia objects 311 (triangle and square), text 312, and photo and/or video objects 314. Multimedia objects further include, but are not limited to, pictures, photographs, videos, video materials, digital renderings, audio files, text, animations, and data/information associated therewith.

The user can also annotate or interact with one or more objects displayed using multimedia window 310. For example, the user can underline text 312 with annotation 313. The multimedia objects can also provide various control parameters in the form of a user interface. For example, the control parameters include annotation controls 315a-n, which allow the user to, for example, control the display characteristics of annotation 313. Control object 315a may be selected to annotate in red, control object 315b may be chosen to annotate in blue, and control object 315c may be selected to annotate in black. Control parameters 316a-n include objects that allow the user to choose the type and/or source of the multimedia displayed in the multimedia window 310. Control object 316a may be selected to enable the user to display and interact with a PowerPoint presentation in multimedia window 310 or at another location on display screen 101. Control object 316b allows the user to select an image/video file displayed within multimedia window 310 or at another location on display screen 101. Control object 316c allows the user to choose a web page (e.g., HTML file/link) displayed within multimedia window 310 or at another location on display screen 101. Control object 316d allows the user to select/deselect one or more objects stored in memory (i.e., a digital clipboard containing, for example, XPS content) to be displayed in the multimedia window 310 or at another location on display screen 101.

FIG. 3B depicts multimedia information 310, 315, 316 displayed on the presentation device 100 from the user's perspective. The multimedia information may further include graphical objects 311 such as, for example, a square and a triangle. In some embodiments, the graphical objects 311 (i.e., square and triangle) may be embedded within the information related to multimedia window 310, such as, for example, by being embedded within HTML code pertaining to multimedia window 310. In other embodiments, graphical objects 311 maybe not be embedded within the information associated with graphical window 310 but instead displayed by one or more other components of presentation device 100. For example, a user may utilize writing instrument 202 to draw graphical object 311 as a square and/or triangle. Presentation device 100 may recognize graphical object 311, store it as an object, display it on display screen 101, which the user can manipulate. The device may recognize that the user has drawn a graphical object 311 as a triangle or square and output a corresponding geometrically correct graphical object 311. In such an example, a user hand-draws a square on writing surface 102 using writing instrument 202, and presentation device 100 recognizes that the user's drawing closely represents a square and will, in turn, display a geometrically correct square that approximates the hand-drawn version. This drawing-to-figure or writing-to-text conversion will be understood by one skilled in the art.

Although multimedia objects 310, 311, 312, 314, 315 are shown and described as depicted on display 101 in FIG. 3B, other contemplated embodiments do not depict such multimedia objects being shown on display 101. For example, in an embodiment, multimedia objects 310, 311, 312, 314, 315 are not shown on display 101. Instead, multimedia objects 310, 311, 312, 314, 315 are displayed on a separate monitor, for example, confidence monitor 110. In such embodiments, presentation device 100 displays multimedia objects 310, 311, 312, 314, 315 on confidence monitor 110 that can be annotated and/or manipulated by the user, as discussed herein. For example, multimedia objects 310, 311, 312, 314, 315 may be annotated using a touch-sensitive interface integrated into display screen 101, a touch-sensitive interface integrated into confidence monitor 110, writing instrument 202, or other input-output device, the implementation of which will be readily apparent to one skilled in the art. Multimedia objects 310, 311, 312, 314, 315 are integrated into single output video stream by, for example, processes discussed with respect to FIG. 5.

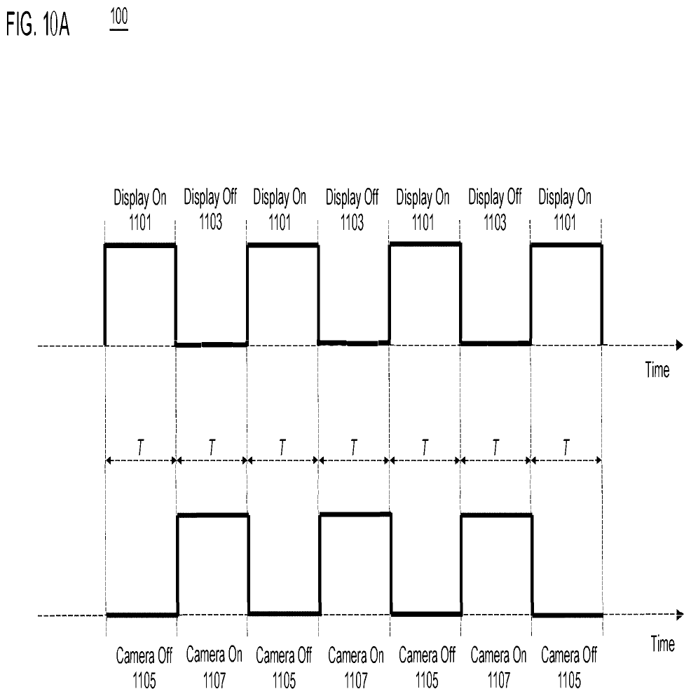

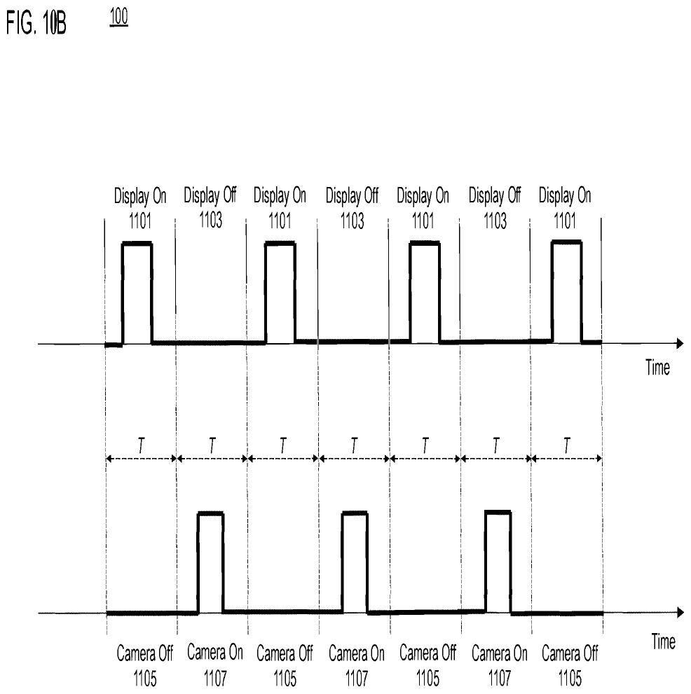

FIG. 3B depicts information displayed on presentation device 100 from the user's perspective. However, as discussed with reference to FIG. 3A, the information will appear to be backward when viewed from the image capture device's 104 or audience's perspective, as shown in FIG. 3C. To correctly display the information appropriately for the audience's perspective, hardware and software are utilized to digitally “flip” the image about a vertical axis. To accomplish this, presentation device 100 may capture the video stream captured by image capture device 104 in tandem with capturing the multimedia information shown on display 101 using screen capture/recording techniques, the application of which will be readily understood and implemented by one of ordinary skill in the art. In this way, presentation device 100 preserves the quality of multimedia information displayed while capturing a video stream of the user and/or annotations. Software applications may then integrate the separately captured video stream and multimedia information into a single output video stream to provide a seamlessly integrated presentation experience for the audience, for example, as discussed with reference to FIG. 5. In other embodiments, image capture device's 104 image capture cycle is 180° out of phase with display screen's 101 digital display cycle, as discussed in more detail with respect to FIGS. 10B, 11A, and 11B.

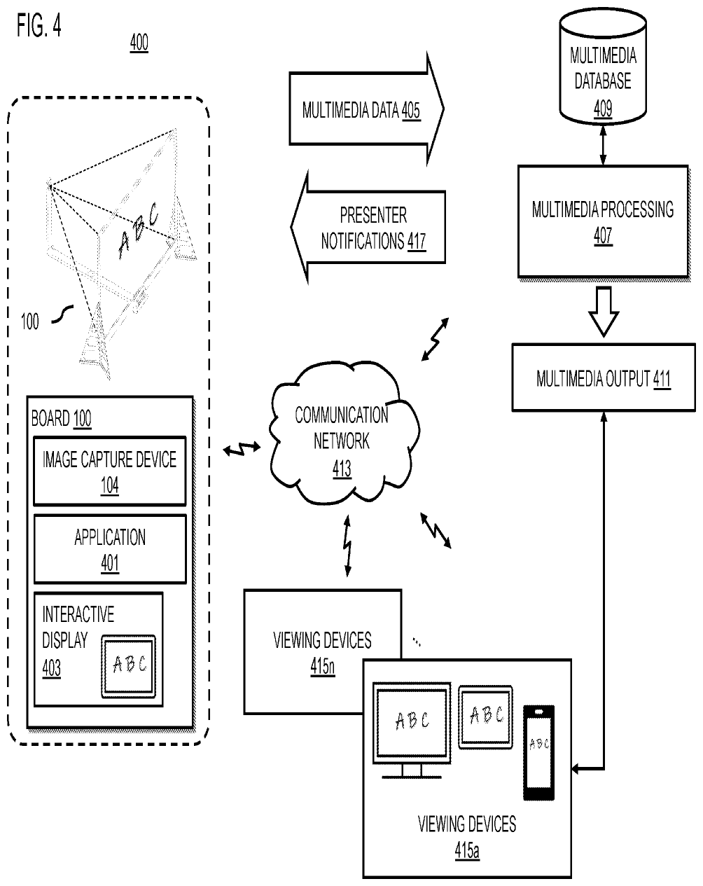

In another exemplary embodiment of the present invention and with reference to FIG. 4, a system for capturing board writing 400 captures writings 201 and transmits the information to viewing devices 415(a)-(n). Although discussion concerning FIG. 4 is made herein with specific reference to capturing, annotating, distributing, or viewing writings 201, the system may equally apply those principles/techniques to any digital or graphical object displayed on display screen 101, including multimedia window 310, multimedia objects 311, text 312, annotation 313, photo/video objects 314, control object 315, control parameter 316, and writing 317. Presentation device 100 comprises integrated image capture device 104 and application 401 configured to control various aspects of system 400 or to effectuate processes/techniques described herein. Presentation device 100 may further comprise a controller/interactive display 403. Interactive display 403 may also comprise confidence monitor 110. Once image capture device 104 captures multimedia information, including writing 201 (e.g., video, multimedia information 310, 311, 312, 317, or annotation 313), the multimedia information is transmitted for multimedia processing at step 407. The multimedia information is transmitted across communication network 413. As part of the processing, system 400 reorientates a visual component about a vertical axis, as discussed herein.

Multimedia processing 407 may further include integrating multimedia information captured by image capture device 104 with multimedia information shown on display 102 (e.g., 310, 311, 312, 313, 314, and/or 317). In this way, system 400 provides a single video stream containing all visual elements, including the user, to provide the audience with a superior viewing experience. System 400 stores the multimedia information in multimedia database 409, either before or after processing. Once processed, the multimedia information is outputted, at step 411, to various devices. For example, the processed multimedia information can be sent to viewing devices 415a-n. Such viewing devices 415a-n may include televisions, monitors, computers, desktop computers, laptop computers, kiosks, smartphones, portable electronic devices, tablets, or any other device comprising a display screen. One or more of the viewing devices 415a-n may communicate with other viewing devices 415n through the communication network 413 or directly, for example, via Bluetooth. In an embodiment utilizing built-in video conferencing, for example, the viewing devices 415a-n may be associated with participants in the teleconference along with the user of presentation device 100. In embodiments implementing a confidence monitor 110, one or more of viewing devices 415a-n may operate as or integrated into confidence monitor 110. Communication network 413 may be the internet or any wired or wireless communication network, the identification and implementation of which are apparent to one of ordinary skill in the art.

One or more viewing devices 415a-n can send information to the user and/or presentation device 100. In such an example, a user of viewing device 415a can send, for example, user notification 417 to display screen 101 or other components thereof. Notification 417 can be displayed, for example, on interactive display 403. In the context of a classroom setting, a student using viewing device 415a can, for example, send question 417 to the instructor (i.e., user) using presentation device 100. The question/notification 417 may then be displayed on display 403. The instructor may use interactive display 403 or application 401 to answer or cancel question 417. Question/notification 417 can also be displayed on one or more of viewing devices 415n. Other students using viewing devices 415n may also be able to answer/cancel question 417 with or without input from the user/instructor using presentation device 100. Although user notification 417 is discussed in the context of a question from a student to an instructor, any notification or information may be sent to and/or from the viewing devices 415a and the display 403, any notification may be exchanged between any/all of the viewing devices 415a and the presentation device 100 without departing from the contemplated embodiments.

With reference to FIG. 5, the invention enables various modules to effectuate the features, processes, and techniques discussed herein, for example, as depicted at multimedia processing 407 and/or multimedia output 411. To implement process 500, at step 501, data may be input. For example, multimedia objects, images, text, HTML, files, web pages, 3D objects, or formatted rich text may be imputed by a user using wiring instrument 202 or other input/output devices such as a mouse and keyboard. The information can also be directly inputted by the user, i.e., drawn or handwritten, or imported from a database, e.g., database 409.

At step 503, a background processor may be implemented to remove unwanted or unnecessary visual information, e.g., the background, from a multimedia object. In an exemplary embodiment, a user may wish to input a photo or picture. The background processor will then detect and remove information that is visually insignificant, e.g., remove the whitespace or background from the photo or picture. In some embodiments, the user can specify what areas of the photo or picture are removed by, for example, selecting the unwanted portions with writing instrument 202 or, conversely, selecting the desired portions. Once specified, the background processing module removes the unwanted portions of the photo or picture, the implementation of which will be understood by one skilled in the art. In this way, the background processing module removes information from multimedia objects that has the added benefits of requiring less space for storage and transmission, thereby reducing latency. Additionally, removing unwanted portions of a multimedia object enhances the audience's viewing experience by omitting irrelevant information.

In another embodiment, the background processor provides the effect of removing the background by creating a new multimedia object based on the inputted multimedia object with characteristics and/or attributes that are more conducive to implementing the features described herein. For example, a user may input a digital photo to be depicted on display 102. In this example, the inputted digital photo has a very high resolution that is desired to increase the presentation experience. However, such a file will be large and will require a large amount of storage space, bandwidth, and processing power to store, transfer, and manipulate. Instead of excising the unwanted portions of the digital photo, the background processing module, at step 503, may, for example, create an image vector map based on the inputted digital photo, the implementation of which will be apparent to one skilled in the art. The resulting vector map image will take less space, require fewer computing resources to manipulate, and require less bandwidth to transfer while maintaining the visual experience of the high resolution inputted digital photo. Additionally, in creating such a vector map image, the background processing module can remove the unwanted portions of the image background of the image.

At step 505, a file manager additionally processes objects inputted at step 501. The file manager may process objects by converting them into another format that allows process 500 to display such objects. The file manager may additionally provide a user interface to manage files and folders. For example, the file manager may create, open (e.g., view, play, edit, or print), rename, copy, move, delete, or search for files, as well as modifying file attributes, properties, and file permissions. The file manager may cause the display folders or files in a hierarchical tree based on their directory structure. In some embodiments, the file manager may move multiple files by copying and deleting each selected file from the source individually. In other embodiments, the file manager copies all selected files, then deletes them from the source. In other embodiments, the file manager may include features similar to those of web browsers, e.g., forward and back navigational buttons. In other embodiments, the file manager provides network connectivity via protocols, such as FTP, HTTP, NFS, SMB, or WebDAV. In another embodiment, the file manager may provide a flattened and/or rasterized image. For example, multimedia objects often contain multiple layers of information, much of which is not be required to implement the features of the present invention. Flattening such an image reduces the overall size of the file by removing information relating to portions of the object that are not visible. The file manager may further include and/or use temporary memory (e.g., RAM) in which data or information may be stored during the implementation of the features described herein.

At step 507, a renderer further processes the information to be displayed on presentation device 101. The renderer may process the image and optimize it for its visual presentation. For example, the renderer may perform adjustments pertaining to the color, the color's intensity, brightness, and contrast. In this way, the renderer maximizes the visual experience be ensuring that information displayed on display 101 is optimized for the conditions under which it is displayed. In an example where the multimedia object is a picture, the renderer may adjust the color, e.g., the picture's tint or hue, to ensure that it is displayed with visually correct colors when depicted on display 102. This ensures that the picture does not appear too green or yellow when displayed. In another example where the multimedia object comprises a presentation window, the renderer will, for example, adjust and/or optimize the size, location, and/or opacity of the presentation window. The renderer may also cause the presentation window to scroll or pan, incrementally or by skipping pages, either based on predetermined criteria or based on the user's input, e.g., a user using a mouse wheel or some other input/output device to scroll up or down. The renderer may also adjust the appearance of rich media objects by zooming, scaling, or inverting the colors displayed.

At step 509, a mixer additionally processes the information by, for example, combining the processed multimedia objects 310, 311, 312, 313, 314, and 317 with video stream captured by image capture device 104 into a single data stream. In an exemplary embodiment, the mixer receives processed data from the renderer module processed at step 507 and also receives data captured by image capture device 104. The mixer combines the received data to generate a single video stream containing all desired visual elements. In an exemplary embodiment, the mixer receives visual information received from the image capture device 104 and the multimedia information shown on display screen 101. For example, the mixer receives a video stream captured by video camera 104. The received video stream includes the user, any annotations the user has made and depicted on display 102, for example, writing 201, 317, and annotation 313 using writing instrument 202. The received video stream may further include multimedia objects, e.g., 310, 311, 312, shown on display screen 101, as captured by video capture device 104. The mixer also receives the same multimedia objects as rendered at step 507. That is, the mixer may receive duplicative information pertaining to multimedia objects 310, 311, and 312. In this example, the visual information pertaining to the multimedia objects 310, 311, and 312 rendered at step 507 are of higher quality and more visually appealing than the information pertaining to those objects captured by video camera 104. In such an example, the mixer, in combining the two streams, uses the information pertaining to the visually superior source, i.e., the mixer uses visual information relating to multimedia objects 310, 311, 312 from the renderer and combines it with the visual information pertaining to the user and handwritten annotations 313, 317 as captured from the video camera 104. The resulting output is a single video stream containing only the appealing and highest quality visual information. The mixer may also ensure the image capture device 104 and display screen 101 are out of phase with one another to capture the user and information unrelated to images displayed on display screen 101, as discussed in more detail below.

In other embodiments, the image capture device 104 and/or display screen 102 are configured such that certain multimedia information shown on display screen 102 is not captured by image capture device 104. By way of example, although multimedia window 310 is depicted on display screen 102 and is visible to the user (not shown), the image capture device 104 does not capture images of multimedia window 310. In such an example, the mixer combines the video stream captured by the video camera 104 and the visual information rendered at step 507 by, for example, superimposing one over the other. In this way, the mixer generates a single video stream that contains the visual presentation elements.

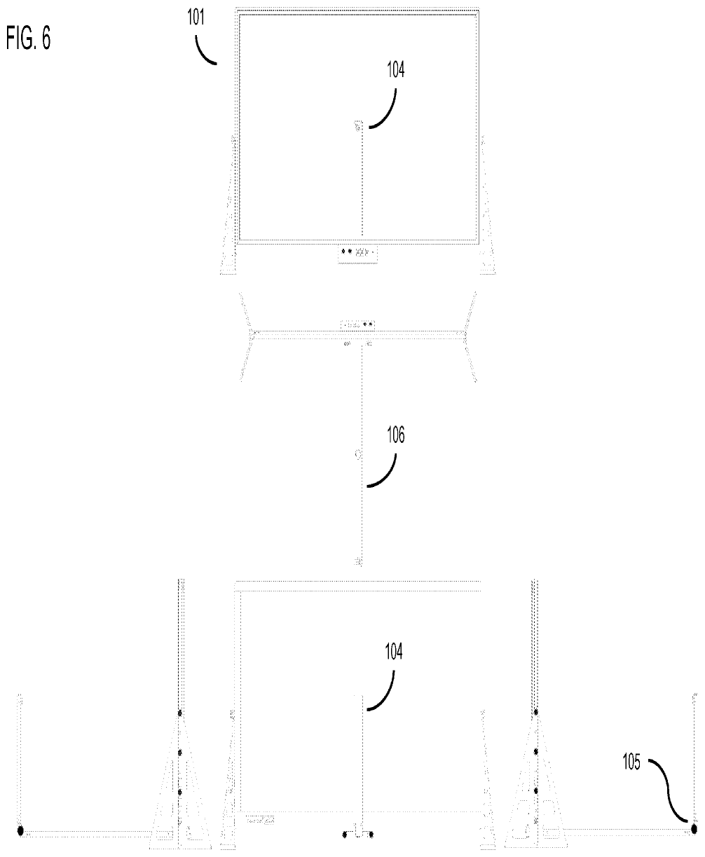

In another exemplary embodiment and with reference to FIG. 6, image capture device 104 can be located lower relative to the display screen 101 than other embodiments, for example, as shown in FIG. 6. Here, an audience member (not shown) would have an easier time viewing the user (not shown). However, in such an embodiment, additional processing may be required to correct perceived deformations in writings 201 caused by the lower aspect angle of the video camera's 104 lower relative position. Such additional processing can occur at multimedia processing 407 as discussed with respect to FIG. 4 or one or more of the steps discussed with respect to FIG. 5.

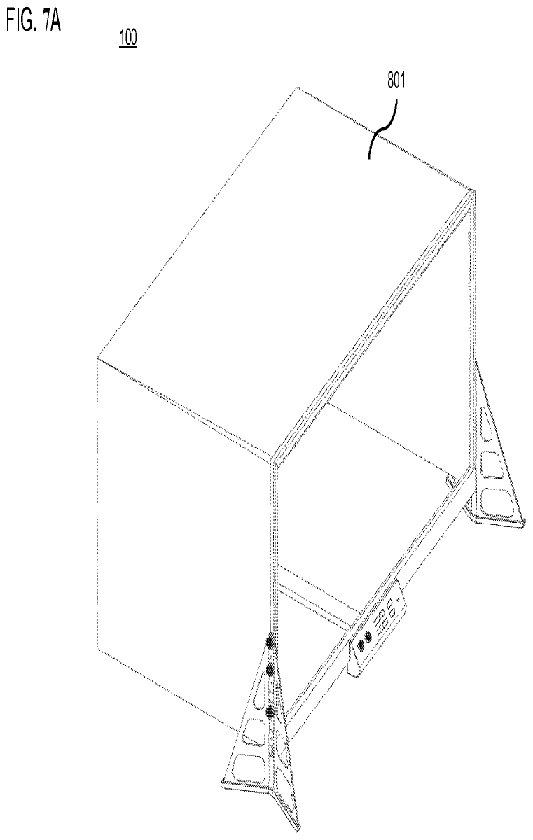

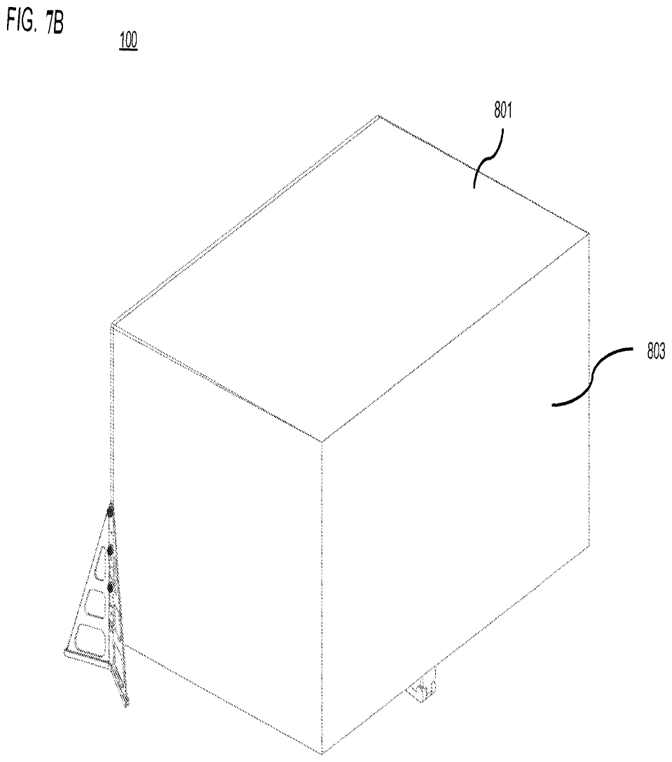

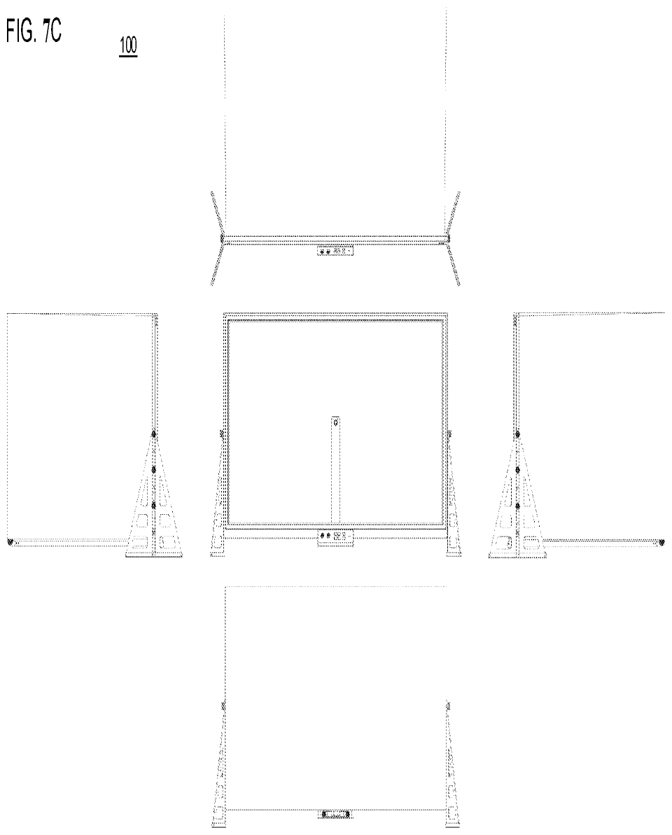

In another exemplary embodiment and with reference to FIGS. 7A, 7B, and 7C, presentation device 100 comprises hood 801. In some embodiments, hood 801 may be made from fabric or other pliable material. Exemplary fabrics include and are not limited to canvas, chenille, chiffon, cotton, crepe, gingham, jersey, leather, linen, polyester, spandex, velvet, and viscose, or a combination thereof. In other embodiments, hood 801 may be made from a rigid or semi-rigid material such as a polymer or plastic. Hood 801 allows the user to control the amount of extraneous light interacting with display screen 101 of presentation device 100. For example, ambient light can degrade the viewing experience by overpowering the injected light, thereby reducing the perceived luminosity of writings 201. Hood 801 attaches to the presentation device 100 and extends from frame 103 in a direction toward image capture device 104. Hood 801 may extend to envelop the entire image capture device 104 or to some length short of image capture device 104. In an exemplary embodiment, a plurality of rods or other support structure may extend from frame 103 in the direction of the image capture device 104. Hood 801 may be extended or retracted anywhere along the length of the rods or support structure to adjust the amount of ambient light that interacts with screen 102. One or more portions of hood 801 may be configured to be transparent or semi-transparent and may comprise, for example, a polarizer, thereby reducing and/or controlling the reflection on display 101.

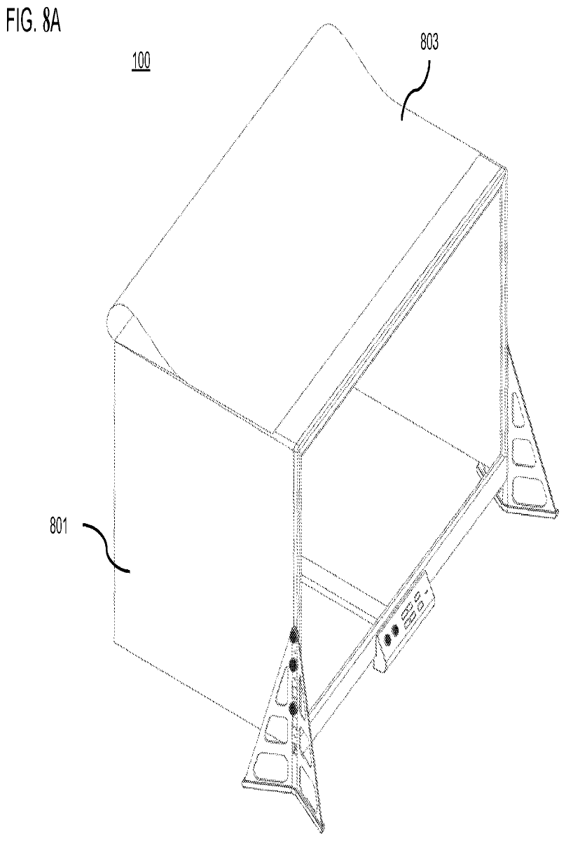

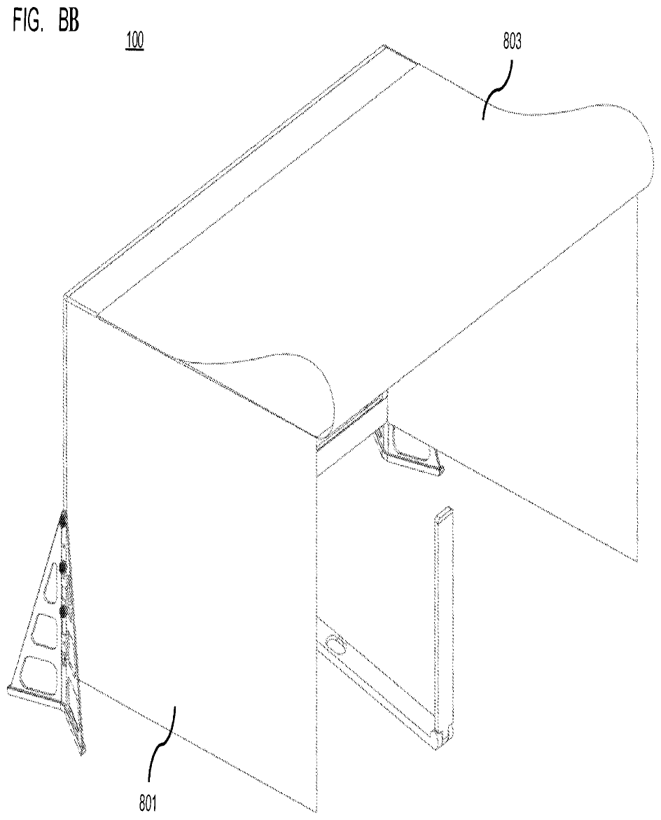

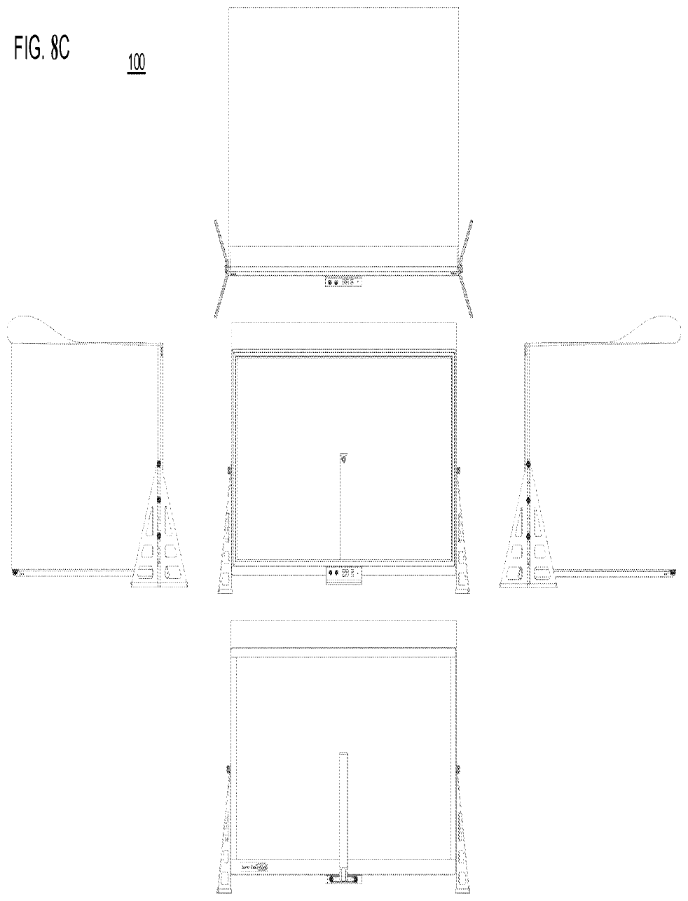

In another embodiment, and with reference to FIGS. 8A, 8B, and 8C, hood 801 may comprise an apron 803. Apron 803 may attach to hood 801 along one side, e.g., the top portion. Apron 803 may be transitionable from a first position (i.e., a closed position) to a second position (i.e., an open position). For example, apron 803 can be user-configurable to an open or a closed state and anywhere in between, depending on lighting conditions. This allows the user to fully enclose one side of the presentation device 100. As such, apron 803 may be opened, thereby allowing the audience the see the user while still maintaining control of the ambient light interacting with the writing surface. Apron 803 may be releasably attached to the hood 801 along one or more sides of the hood 801. Apron 803 may attach to hood 801 using any methodologies known in the art, for example, hook-and-loop fasteners, Velcro, snaps, caps, buttons, or zippers. Hood 801 may optionally be also used for a carrying case for one or more components of the presentation device 100.

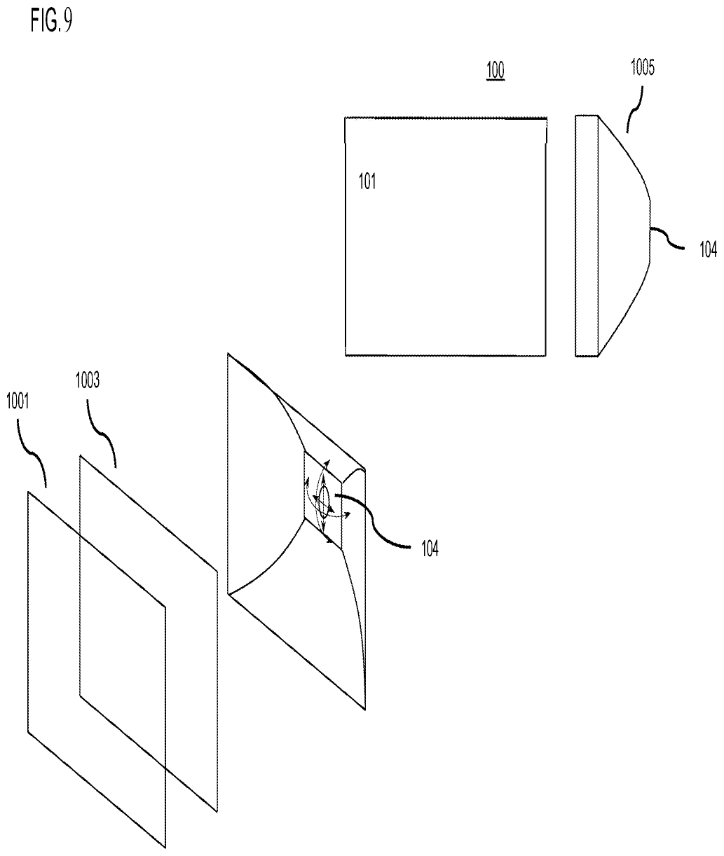

In another exemplary embodiment, and with reference to FIG. 9, the present invention provides an image capture device 104 embedded within a display screen. In an embodiment, for example, the image capture device 104 may be integrated into the display screen 101. In such an embodiment and as previously noted, the display screen 101 may have one or more video cameras embedded into the display 101 that are optimized for use with the display. In such a configuration, the user can look at the display screen, and it will appear as if the user is looking into the eyes of the person receiving the video stream. In said embodiment, the image capture 104 device may be located near or exactly at the center of the display screen 101.

Meanwhile, the cover 1005 comprises any suitable material, for example, any rigid or semi-rigid material including, but not limited to, wood, plastic, metal, or any combination thereof. The cover 1005 can also be angled to act as a frame and shield light pollution from affecting the capturing of media content from the image capture device 104. The cover 1005 can also be flat with no angular shape. Meaning, it is pressed flat or matted against the display screen 101 that encompasses the OLED display and touch panel. The presentation device 100 utilizes specific types and delivery systems for light to enhance the viewer's or user's experience. In an embodiment of the invention, the cover 1005 comprises an embedded light source such as one or more LEDs to inject light into the display screen 101. The effect highlights dry-erase ink, preferably neon dry erase ink, deposited on the writing surface 101. The injected light may be in the visible spectrum or outside the visible spectrum, such as ultraviolet, i.e., blacklight or infrared. In another embodiment, the display screen 101 is one OLED display with a touch panel and light from the OLED display illuminates the dry-erase ink deposited on the writing surface 101. Thus, in this embodiment, the cover 1005 may not comprise LEDs.

In an exemplary embodiment of the present invention, the cover 1005 houses a computer that features a processor, memory, and computer program code. The computer housed within the cover 1005 runs software and computer program code that controls all of the interactions and functioning of the presentation device 100. The cover 1005 also can encompass the display screen 101 to act as a monitor where a control board or motherboard controls the presentation device's 100 features from the display screen 101. In addition, a keyboard is either wirelessly connected or wired to the presentation device 100 and controls the display screen's 101 functions.

Referring to FIG. 9, in some embodiments, the display screen 101 comprises a touch-sensitive panel 1001. Exemplary touch-sensitive panels 1001 comprise an infrared or capacitive touch panel. The display screen 101 may also comprise digital display 1003 embodied by, for example, an LCD or OLED display. The presentation device 100 comprises an image capture device 104 positioned by extension 1005. The image capture device 104 may be further configured to move and/or rotate about one or more axes. As depicted in FIG. 9, image capture device 104 is rotatable about two axes, i.e., up-and-down, left-and-right (indicated by arrows). Additionally, image capture device 104 may be configured so that its position relative to display screen 101 is adjustable. For example, image capture device 104 may be configured to move vertically and horizontally instead of or in addition to being rotatable. Although not shown, image capture device 104 may be configured to move closer to or farther from the display screen, i.e., movable about the z-axis. By achieving more degrees of freedom, image capture device 104 can more accurately adjust its position and viewing angle, which helps ensure the user is always looking at image capture device 104. In this way, movable image capture device 104 enhances the presentation experience. Although image capture device 104 may be shown and described as orientable about four axes, any number of axes, including six, may be utilized without departing from the contemplated embodiments. The presentation device 100 or another external computing device coupled thereto may control the direction or orientation of image capture device 104. Additionally, presentation device 100 may comprise one or more sensors and other hardware and software that enable presentation device 100 to track the eye position and/or the head position of the user, the implementation of which will be readily understood by one skilled in the art. In such an embodiment, presentation device 100 periodically reorients image capture device 104 to be pointed at the user's eyes and/or head. In this way, image capture device 104 will be continuously oriented at the user's eyes or head, further enhancing the viewing experience. This helps maintain the human “eye-to-eye” contact that is lost using conventional videoconferencing techniques. To implement such a presentation device 100, image capture device 104 and display 101 may be optimized to work in conjunction with each other.

In some embodiments, cover 1005 has a predetermined depth to ensure that image capture device 104 captures the entire display screen 101 within its field of view. In an alternate embodiment, image device 104 may be disposed on a surface of the display 1003.

In some embodiments, presentation device 100 utilizes one or more external computers with applications loaded thereon to control one or more of the processes to implement the embodiments described herein. In other embodiments, presentation device 100 comprises an on-board computer running applications to implement one or more processes described herein.

For example, and with reference to FIGS. 10A and 10B, image capture device 104 and digital display screen 101 (e.g., LCD, LED, or OLED displays) are configured to be out of phase with each other. In such an example, display 101 fires when image capture device 104 is in-between frame captures. In this way, the display 101 does not interfere with the video stream captured by image capture device 104. As depicted in FIG. 10A, when the display 101 fires, denoted as “Display On” at step 1101, image capture device 104 is not capturing information, denoted as “Camera Off” at step 1105. These oscillating periods of “Display On” and “Display Off” may be referred to as the display cycle. Conversely, when display 101 is not firing, denoted as “Display Off” at step 1103, image capture device 104 is capturing information, denoted as “Camera On” at step 1107. Such a cycle can be continuously implemented such that image capture device 104 does not capture information displayed on display screen 101. The depicted cycle can be implemented over some time interval T. For example, in an embodiment where display screen 101 refreshes at a rate of 120 Hz (e.g., a display cycle of 120 Hz), the time interval Twill be approximately 8.33 milliseconds. Any time interval may be applied without departing from the contemplated embodiments by, for example, implementing the following relationship:

$$T = \frac{1}{Refresh Rate}$$

As used in the previous example,

$$T = \frac{1}{Refresh Rate} = \frac{1}{[ 120 Hz ]} = 0.0 \; 08333 seconds = 8.333 ms$$

Using the exemplary relationship noted above, any refresh rate can be used. For example, display cycles of 24 Hz (24 fps), 30 Hz (30 fps), 60 Hz (60 fps), 75 Hz (75 fps), 120 Hz (120 fps), 144 Hz (144 fps), and 240 Hz (240 fps) can be implemented without departing from the contemplated embodiments.

The Display On 1101 and the Display Off 1103 may be referred to as the display cycle and is generally characterized by the oscillating periods of display 101 firing. Similarly, the Camera Off 1105 and Camera On 1107 may be referred to as the capture cycle and is generally characterized by the oscillating periods of image capture device 104 capturing visual information and not capturing visual information. In some embodiments, the display cycle may be detected by one or more sensors. For example, a photoelectric sensor may be implemented that detects when the display 101 is firing and when it is not. In this way, the present invention can detect the display cycle and, in turn, adjust or update the capture cycle or capture frequency of the image capture device 104.

Although image capture device 104 is shown as beginning its capture immediately after display 101 completes its display cycle, other embodiments may include a gap in time between the alternating cycles. For example, and as depicted in FIG. 10B, there may be some time between one component completes its cycle, and another component begins its cycle. This may be dictated by the particular hardware or software utilized to implement the contemplated embodiments. The display on cycle may be detected via a sensor mounted to display 101 that detects light from the firing of one or more of the display's light sources. For example, the sensor may be a photoelectronic device, which is coupled to control circuitry for image capture device 104. By implementing a predetermined threshold for the output of the photoelectronic device, the control circuitry can cycle image capture device 104 off and on synchronously with the respective on and off firing of display 101. Such a configuration permits the use of an off-the-shelf display without any special knowledge of their inner electronic workings, which may be proprietary. Alternatively, presentation device 100 may use a controller to control the display cycle of display 101. In such an embodiment, the controller may comprise a high definition multimedia interface (HDMI) input and output. Presentation device 100 may use the controller to dictate the display cycle. In such an embodiment, the controller may be synchronized with image capture device 100 and may further control the capture cycle. In this way, presentation device 100 ensures that the display cycle and the capture cycle do not interfere with one another.

While the invention has been described in connection with a number of embodiments and implementations, the invention is not so limited but covers various apparent modifications and equivalent arrangements, which fall within the purview of the appended claims. Although features of the invention are expressed in certain combinations among the claims, it is contemplated that these features can be arranged in any combination and order. The invention has been described herein using specific embodiments for illustrative purposes only. It will be readily apparent to one of ordinary skill in the art, however, that the principles of the invention can be embodied in other ways. Therefore, the invention should not be regarded as limited in scope to the specific embodiments disclosed herein; it should be fully commensurate in scope with the following claims.

We claim:

1. A device comprising:
a display screen;
a frame traversing at least a portion of a perimeter of the display screen, wherein the frame comprises a light source injecting light into an edge of the display screen;
an extension comprising a distal end and a proximal end, wherein the proximal end of the extension is connected to the frame;
a hood; and
an image capture device integrated into the display screen.

2. The device of claim 1, wherein the hood comprises:
a left panel extending from the device toward the image capture device;
a right panel extending from the device toward the image capture device;
a top panel extending from the device toward the image capture device; and
an apron extending from the top panel, wherein the apron is convertible from a first position to a second position.

3. The device of claim 2, wherein the hood is removably attached to the frame.

4. The device of claim 2, further comprising a hood support extending from the frame toward the image capture device.

5. The device of claim 4, wherein the hood support comprises a plurality of rods.

6. The device of claim 4, wherein the hood further comprises at least a second light source.

7. The device of claim 6, wherein the at least second light source provides backlighting for the display screen.

8. The device of claim 1, wherein the display screen further comprises a touch-sensitive panel.

9. The device of claim 1, further comprising a display cycle comprising oscillating periods of displaying visual information and not displaying visual information on the display screen.

10. A method of capturing visual information, the method comprising the steps of:
injecting, from a light source integrated into a frame, light into a transparent display screen, wherein the frame traverses at least a portion of the transparent display screen;
capturing, with an image capture device, a first video stream, wherein the image capture device is integrated into the transparent display screen;
generating an output video stream; and
outputting the output video stream over a network.

11. The method of claim 10, wherein the step of generating an output video stream comprises the steps of:
receiving the first video stream from the image capture device;
reorienting the first video stream about a vertical axis;
receiving a second video stream, the second video stream comprising multimedia information displayed on a display screen; and
merging the first video stream and the second video stream into the output video stream.

12. The method of claim 11, wherein the step of merging the first video stream and the second video stream comprises the steps of:
detecting a set of visual objects in the second video stream;
adjusting visual characteristics of the set of visual objects, the visual characteristics relating to opacity, tint, hue, brightness, color intensity, or size of the set of visual objects; and
superimposing the adjusted set of visual objects onto the first video stream.

13. The method of claim 11, further comprising the step of displaying a graphical user interface on the display screen, wherein the graphical user interface is configured to adjust visual characteristics.

14. The method of claim 11, further comprising the step of adjusting the amount of ambient light interacting with the display screen by adjusting an apron of a hood, the apron adjustable between a first position and a second position, wherein the hood comprises:
a left panel extending from the device toward the image capture device;
a right panel extending from the device toward the image capture device; and
a top panel extending from the device toward the image capture device, wherein the apron extends from the top panel of the hood.

15. An apparatus comprising:
a display screen comprising a display cycle characterized by oscillating periods of displaying visual information and not displaying visual information at a display frequency;
a frame traversing at least a portion of a perimeter of the display screen; and
an image capture device integrated into the transparent display screen and comprising an image capture cycle characterized by oscillating periods of capturing visual information and not capturing visual information at a capture frequency; and wherein the display cycle of the transparent display screen is offset by 180 degrees from the image capture cycle of the image capture device.

16. The presentation device of claim 15, wherein the image capture device is movable about a vertical axis and a horizontal axis and is pivotable about the vertical axis and the horizontal axis.

17. The presentation device of claim 16, wherein the image capture device's orientation or position is periodically adjusted.

18. The device of claim 15 further comprising a photoelectric sensor configured to detect the display cycle or the display frequency of the transparent display screen.

19. The device of claim 18, wherein the image capture frequency or the image capture cycle is periodically adjusted based on an output of the photoelectric sensor.

20. The device of claim 15 further comprising:
a touch-sensitive panel on the display screen;
at least one processor;
at least one memory including computer program code for one or more programs, the at least one memory and the computer program code configured to, with the at least one processor, cause the apparatus to perform at least the following,
capturing, with the image capture device, information presented on the display screen;
processing the captured information; and
transmitting the processed information to a display.
